(19) United States
(12) Patent Application Publication
(10) Pub. No.: US 2026/0212278 A1
(43) Pub. Date: Jul. 23, 2026

(54) METHOD AND APPARATUS FOR FEDERATED LEARNING

(71) Applicant: SAMSUNG ELECTRONICS CO., LTD., Suwon-si (KR)

(72) Inventors: Rui LI, Chertsey (GB); Stylianos VENIERIS, Chertsey (GB); Young D. KWON, Chertsey (GB); Javier FERNANDEZ-MARQUES, Chertsey (GB); Konstantin MISHCHENKO, Chertsey (GB); Alexandros KOURIS, Chertsey (GB)

(73) Assignee: SAMSUNG ELECTRONICS CO., LTD., Suwon-si (KR)

(21) Appl. No.: 19/644,648

(22) Filed: Apr. 10, 2026

Related U.S. Application Data
(63) Continuation of application No. PCT/KR2024/004968, filed on Apr. 12, 2024.

(30) Foreign Application Priority Data
Oct. 12, 2023 (GR) 20230100845
Dec. 5, 2023 (EP) 23214225.7

(51) Int. Cl. G06N 20/00

(52) U.S. Cl. CPC G06N 20/00

(57) ABSTRACT

A method for performing federated learning on progressively available data, which is suitable for implementation by resource-constrained devices, such as smartphones and edge devices is provided. A method includes obtaining, instructions to begin a FL round, determining a mode to use during the FL round, wherein the mode is one of a streaming mode involving sub-epoch training and a non-streaming mode involving epoch training, training, using the determined mode, a local ML model stored at the client device, the local ML model corresponding to the global ML model and transmitting a plurality of updated parameters of the local ML model when the training is complete.

### CROSS-REFERENCE TO RELATED APPLICATIONS

This application is a continuation of International Application No. PCT/KR2024/004968, filed on Apr. 12, 2024, which is based on and claims priority to Greek Patent Application No. 20230100845 filed on Oct. 12, 2023, in the Greek Patent Office, and European Patent Application No. 23214225.7 filed on Dec. 5, 2023, in the European Patent Office, the disclosures of which are incorporated by reference herein in their entireties.

### BACKGROUND

### 1. Field

The present disclosure generally relates to a method and apparatus for federated learning. In particular, the disclosure provides a federated learning process which is suitable for implementation using resource-constrained devices, such as smartphones and edge devices.

### 2. Description of Related Art

Federated Learning (FL) has become a popular area of research in recent years thanks to its privacy-preserving nature and capability to utilise the compute power of millions of user devices for the training of ML models. Federated learning is a well-established machine learning technique in which a global ML model-usually stored on a server-is trained via multiple independent training sessions executed by local or client devices using those devices' own datasets. Each local/client device is supplied with a copy or version of the global ML model for local training. Each client device transmits updated parameters of the locally-trained model to the server for aggregation. The updated parameters may be weights and/or biases of the ML model (or of a neural network thereof). Federated learning involves multiple rounds or iterations of local training and aggregation. To ensure good performance of a final, global ML model, federated learning may rely on an iterative process, where each interaction between a client device and server is known as a federated learning round. Each round or iteration involves transmitting the current global model to client devices, performing local training of the model on these client devices to produce a set of potential model updates at each client device, and then aggregating and processing these local updates into a single global update and applying it to the global model.

Related work on FL has been widely focused on scenarios where client data (i.e. data items located on a client device) are readily available for training, i.e. the data distribution is known upfront and the whole dataset can be stored in the memory of the client device. In real-world deployments, however, the data are more likely to be generated on-the-fly, the data distributions can change with time, and the client device has limited memory capacity. These aspects have been partially addressed only very recently in an oversimplified setting, which does not take into account the memory constraints of mobile devices and the upstream communication cost.

Furthermore, upcoming ML architectures, such as Transformers, have recently paved the way in applications such as computer vision, speech recognition, robotic control, and natural language processing. Nonetheless, such models intrinsically have significantly larger memory demands during training. This fact either prevents or hinders memory-constrained client devices to perform local training, which in turn prevents the deployment of Transformer models in FL setups.

The disclosure has provided the need for an improved federated learning process that can be implemented across resource-constrained devices.

### SUMMARY

According to an embodiment of the disclosure, a computer-implemented method for adaptable federated learning, FL, of a global machine learning, ML, model, at a client device is provided. The method may include obtaining, instructions to begin a FL round. The method may include determining a mode to use during the FL round, wherein the mode is one of a streaming mode involving sub-epoch training and a non-streaming mode involving epoch training. The method may include training, using the determined mode, a local ML model stored at the client device, the local ML model corresponding to the global ML model. The method may include transmitting a plurality of updated parameters of the local ML model when the training is complete.

According to an embodiment of the disclosure, a client device for adaptable federated learning, FL, of a global machine learning, ML, model is provided. The client device may include at least one processor coupled to memory for obtaining, from a server, instructions to begin a FL round. The client device may include at least one processor coupled to memory for determining a mode to use during the FL round, wherein the mode is one of a streaming mode involving sub-epoch training and a non-streaming mode involving epoch training. The client device may include at least one processor coupled to memory for training, using the determined mode, a local ML model stored at the client device, the local ML model corresponding to the global ML model. The client device may include at least one processor coupled to memory for transmitting a plurality of updated parameters of the local ML model to the server when the training is complete.

According to an embodiment of the present disclosure, a computer-readable storage medium which is configured to store instruction is provided. The instructions, when executed by the at least one processor, may cause the at least one processor to perform the method corresponding.

According to an embodiment of the disclosure, a computer-implemented method for adaptable federated learning, FL, of a global machine learning, ML, model, at a client device is provided. The method may include receiving, from a server, instructions to begin a FL round. The method may include determining a mode to use during the FL round, wherein the mode is one of a streaming mode involving sub-epoch training and a non-streaming mode involving epoch training. The method may include training, using the determined mode, a local ML model stored at the client device, the local ML model corresponding to the global ML model. The method may include transmitting a plurality of updated parameters of the local ML model to the server when the training is complete.

In an embodiment, the present disclosure enable a client device to determine a mode to use when performing local training of a locally-stored copy of the global ML model during a federated learning, FL, process. In an embodiment, this is advantageous because client devices have different hardware capabilities and memory-constrained client devices may find it difficult or impossible to perform local training of ML models that are computationally-expensive to train, such as those based on Transformers. It is useful to include as many client devices as possible in an FL process, to reduce training biases. In an embodiment, client devices need to transmit parameters of their locally-updated ML model to a server for aggregation into the global ML model, but this relies on having a good communication connection, such as a stable WiFi or mobile/cellular network connection and a high bandwidth connection. For unstable connections and/or low bandwidth connections, it becomes much more difficult for client devices to transmit the parameters to the server, especially when a size of data to be transmitted to the server is large.

In an embodiment, the present disclosure enable a client device to choose whether to operate in a streaming mode or a non-streaming mode when performing a FL round. In an embodiment, the present disclosure, also referred to herein as “StreamingFL” enable client devices to stream their local updates to the server as soon as they become available. The streaming mode is a mode in which the client device performs incremental local training of the local ML model, and incremental transmission of updated model parameters, based on when the client device has data items available for training, the memory available for training, and a quality of the communication connection. An epoch in the training of an ML model is when a whole training dataset is used for training of the ML model. In an embodiment, one entire pass of training data through the ML model is an epoch. The server may specify a required number of data items to be used in an epoch, e.g. a target batch size (e.g. a target number of data items to be used during each FL round). In an embodiment, during an FL round, the server may specify how many epoch updates are to be performed, and how many data items need to be used during each epoch update. In the streaming mode, rather than waiting to obtain the required number of data items to train the ML model, the client device passes the data items it already has (actual batch size) through the ML model. In an embodiment, the streaming mode involves sub-epoch updates, e.g. updates which occur using less than the required number of data items for an epoch update. The parameters of the updated ML model are shared with the server at the end of each sub-epoch. In contrast, the non-streaming mode is a mode in which the client device performs epoch updates only. In an embodiment, in the non-streaming mode, the client device waits until it has obtained the required number of data items to train the ML model, and then passes the obtained data items through the ML model. The parameters of the updated ML model are shared with the server at the end of the epoch.

In an embodiment, the present disclosure also enables a client device to use a different mode when conditions change (e.g. rate of arrival of new data items for training, memory availability, and/or quality of communication connection), when starting another FL round. In an embodiment, the client device re-assesses conditions at the start of another FL round and may switch to a different mode or use the same mode as per the previous FL round.

The method may comprise receiving, from the server, current parameters for a local ML model at the start of the FL round, wherein the current parameters are obtained from a global ML model. The method may comprise modifying the local ML model using the received current parameters. The method may comprise obtaining current parameters for a local ML model at the start of the FL round, wherein the current parameters are obtained from a global ML model. The method may comprise modifying the local ML model using the obtained current parameters. In other words, at the start of an FL round, the client device receives the current parameters of a local ML model to be trained. The current parameters may be generated, at the server, by conducting an aggregation of the local ML models from client devices that participated in the previous FL round. (Aggregation is generally the final step of an FL round). In this way, the client device trains the most up-to-date version of the local ML model during each FL round.

Determining a mode to use, i.e. streaming or non-streaming, during the FL round may be based on a current communication network speed of the client device and a size of the local ML model (where “size of the local ML model” means the total number of parameters of the model). In an embodiment, as mentioned above, a quality of the communication network/connection is used to determine whether to use a streaming mode or non-streaming mode. A streaming mode may be used when the communication network speed is currently high. This means that a client device would still perform training of the local ML model, but using fewer data items than required for a full epoch, and transmit the updated parameters to the server more often. This is because in the streaming mode, the client device does not need to wait to obtain all of the training data items needed for a full epoch. Instead, the client device performs sub-epoch updates with currently available training data items and rapidly transmits the updated parameters to the server after each sub-epoch update. The computational inefficiency (i.e. reduced amount of computation per communication round compared to a full-epoch approach) is balanced by the reduction in pressure on the hardware resources of the client device (i.e. shorter time occupying the processor of the client device).

Receiving instructions to begin a FL round may comprise receiving a predefined FL round duration and a predefined minimum number β of model updates to be performed in the FL round duration. Obtaining instructions to begin a FL round may comprise obtaining a predefined FL round duration and a predefined minimum number of model updates to be performed in the FL round duration. In an embodiment, the server may specify how many epochs (also referred to as updates) are to be performed in each FL round. The server may also specify a number of data items that need to be included in each epoch.

Determining a mode to use during the FL round may comprise determining a number p of updates that the client device is able to perform during the FL round. Determining a mode to use during the FL round may comprise comparing the received predefined minimum number β of model updates to be performed with the determined number of updates p. Determining a mode to use during the FL round may comprise determining the streaming mode is to be used when the received predefined minimum number β of model updates to be performed is less than the determined number of updates p the client device is able to perform. Determining a mode to use during the FL round may comprise determining a number of updates that the client device is able to perform during the FL round. Determining a mode to use during the FL round may comprise comparing the obtained predefined minimum number of model updates to be performed with the determined number of updates. Determining a mode to use during the FL round may comprise determining the streaming mode is to be used in response to the obtained predefined minimum number of model updates to be performed is less than the determined number of updates the client device is able to perform. Thus, the client device compares what is required by the server with what the client device is able to perform, given a number of factors.

In an embodiment, determining a number p of updates that the client device is able to perform during the FL round may be based on an arrival rate of data items at the client device, where the data items are for training the local ML model. Determining a number p of updates that the client device is able to perform during the FL round may be based on the predefined FL round duration. Determining a number p of updates that the client device is able to perform during the FL round may be based on a batch size of a batch of data items for training the local ML model. How these factors may be used to determine the number of updates that the client device is able to perform is explained in more detail below with respect to the Figures.

The method may comprise determining the batch size based on an available memory of the client device for the training of the local ML model and the size of the local ML model. In an embodiment, the hardware capabilities of the client device are taken into consideration when determining the batch size. If a client device has lots of memory available because, for example, it is not resource-constrained or because memory is not being utilised presently, then the batch size may be larger. The client device may choose when to perform the FL round, to ensure there is sufficient memory available. For example, if the client device is a smartphone, the client device may perform the FL round when the smartphone is being charged or when the device is in a ‘do not disturb’ state (as may be the case when a user of the device is asleep).

Some example scenarios are now described to illustrate when a streaming mode or non-streaming mode may be used.

The method may comprise determining that the streaming mode is to be used when: the size of the local ML model is equal to a predefined size m. The method may comprise determining that the streaming mode is to be used when the current communication network speed is determined to be equal to a threshold speed. The method may comprise determining that the streaming mode is to be used when the received predefined minimum number β of model updates to be performed is less than the determined number of updates p. The method may comprise determining that the streaming mode is to be used when: the size of the local ML model is equal to a predefined size. The method may comprise determining that the streaming mode is to be used when the current communication network speed is determined to be equal to a threshold speed. The method may comprise determining that the streaming mode is to be used when the obtained predefined minimum number of model updates to be performed is less than the determined number of updates. In an embodiment, when a bandwidth or speed is good, and the model is not especially large, a streaming mode is used. If the final condition is not satisfied, i.e. that β is not less than p, then a non-streaming mode is used.

Alternatively, the method may comprise determining that the streaming mode is to be used when the size of the local ML model is greater than a predefined size m multiplied by a scaling factor y. The method may comprise determining that the streaming mode is to be used when the current communication network speed is determined to be equal to a threshold speed. The method may comprise determining that the streaming mode is to be used when the received predefined minimum number β of model updates to be performed is less than the determined number of updates p divided by the scaling factor y. In an embodiment, the method may comprise determining that the streaming mode is to be used when the size of the local ML model is greater than the predefined size multiplied by a second scaling factor. The method may comprise determining the current communication network speed is determined to be equal to a threshold speed. The method may comprise determining that the streaming mode is to be used when the obtained predefined minimum number of model updates to be performed is less than the determined number of updates divided by the scaling factor. In an embodiment, when a bandwidth or speed is good, but the model is large (i.e. bigger than some threshold size), a streaming mode is used. If the final condition is not satisfied, i.e. that β is not less than p/y, then a non-streaming mode is used. Here, the threshold size may be determined by the server by considering hardware capabilities (e.g. computation and memory) of client devices that participate in the federated learning process, so that the threshold size of the model is suitable for execution and training by most or all of the participating client devices. The threshold size may also be determined by the bandwidth of the communication networks used by the participating client devices. The threshold size may evolve over time, as the hardware capabilities and bandwidth may change over time.

In an embodiment, the method may comprise determining that the streaming mode is to be used when the size of the local ML model is equal to a predefined size m. The method may comprise determining the streaming mode is to be used when the current communication network speed is determined to be less than a threshold speed multiplied by a scaling factor x. The method may comprise determining the streaming mode is to be used when the received predefined minimum number β of model updates to be performed is less than the determined number of updates p divided by the scaling factor x. In an embodiment, the method may comprise determining that the streaming mode is to be used when the size of the local ML model is equal to the predefined size. The method may comprise determining the streaming mode is to be used when the current communication network speed is determined to be less than a threshold speed multiplied by a first scaling factor. The method may comprise determining the streaming mode is to be used when the obtained predefined minimum number of model updates to be performed is less than the determined number of updates divided by the scaling factor. In an embodiment, when a bandwidth or speed is poor, and the model is not especially large, a streaming mode is used. If the final condition is not satisfied, i.e. that β is not less than p/x, then a non-streaming mode is used.

In an embodiment, the method may comprise determining that the streaming mode is to be used when the size of the local ML model is greater than a predefined size m multiplied by a scaling factor y. The method may comprise determining that the streaming mode is to be used when the current communication network speed is determined to be less than a threshold speed multiplied by a scaling factor x. The method may comprise determining that the streaming mode is to be used when the received predefined minimum number β of model updates to be performed is less than the determined number of updates p divided by y/x. In an embodiment, the method may comprise determining that the streaming mode is to be used when the size of the local ML model is greater than the predefined size multiplied by a second scaling factor. The method may comprise determining that the streaming mode is to be used when the current communication network speed is determined to be less than a threshold speed multiplied by a first scaling factor. The method may comprise determining that the streaming mode is to be used when the obtained predefined minimum number of model updates to be performed is less than the determined number of updates divided by the second scaling factor divided by the first scaling factor. In an embodiment, when a bandwidth or speed is poor, and the model is large (i.e. bigger than some threshold size), a streaming mode is used. If the final condition is not satisfied, i.e. that β is not less than p/(y/x), then a non-streaming mode is used.

The non-streaming mode is most likely to be used when the current communication network speed is low, but may also be used when the speed is high but the model is larger than the threshold size. The non-streaming mode is unlikely to be used when the current communication network speed is high and the model size is equal to the threshold size.

In cases where the non-streaming mode is used, the step of transmitting a plurality of updated parameters of the local ML model to the server may comprise selecting a subset of the plurality of updated parameters and compressing the selected subset prior to the transmitting. In cases where the non-streaming mode is used, the step of transmitting a plurality of updated parameters of the local ML model may comprise selecting a subset of the plurality of updated parameters and compressing the selected subset prior to the transmitting. In an embodiment, the client device may only send some of the updated parameters to the server to avoid increasing the size of the data to be transmitted while the communication network speed is low.

The method may comprise capturing data items for use when training the local ML model during the FL round. The method may comprise obtaining data items for use when training the local ML model during the FL round. The data items may be captured at the arrival rate mentioned above. That is, the client device may actively capture data items for use during the present FL round. If the arrival/capture rate changes, then the updates of the local ML model may be performed at a different frequency too. The data items may be of any type, and depend on the tasks of the local and global ML models. In one example, the global ML model and local ML model are for visual perception tasks, and capturing data items may comprise capturing images or frames of videos. The data items may include some data items that are similar to data items seen by the global ML model during pre-training of the global ML model (prior to the federated learning), and some data items that are different to those seen by the global ML model during pre-training. The visual perception tasks may be object detection, object recognition, object tracking, image denoising, image segmentation, image classification, image super-resolution, and so on. It will be understood that this is a non-limiting and non-exhaustive list of example tasks.

The client device may be a constrained-resource device, but which has the minimum hardware capabilities to use a trained neural network/ML model and to participate in federated learning. The client device may be any one of: a smartphone, tablet, laptop, computer or computing device, virtual assistant device, a vehicle, an autonomous vehicle, a robot or robotic device, a robotic assistant, image capture system or device, an augmented reality system or device, a virtual reality system or device, a gaming system, an Internet of Things device, or a smart consumer device (such as a smart fridge or vacuum cleaner). It will be understood that this is a non-exhaustive and non-limiting list of example client devices.

The features described above with respect to the first approach apply equally to the second approach and therefore, for the sake of conciseness, are not repeated.

As will be appreciated by one skilled in the art, the present disclosure may be embodied as a system, method or computer program product. Accordingly, present disclosure may take the form of an entirely hardware embodiment, an entirely software embodiment, or an embodiment combining software and hardware aspects.

Furthermore, the present disclosure may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present disclosure may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

An embodiment of the present disclosure may also provide a non-transitory data carrier carrying code which, when implemented on a processor, causes the processor to carry out any of the methods described herein.

The disclosure may provide processor control code to implement the above-described methods, for example on a general purpose computer system or on a digital signal processor (DSP). The disclosure may also provide a carrier carrying processor control code to, when running, implement any of the above methods, in particular on a non-transitory data carrier. The code may be provided on a carrier such as a disk, a microprocessor, CD-or DVD-ROM, programmed memory such as non-volatile memory (e.g. Flash) or read-only memory (firmware), or on a data carrier such as an optical or electrical signal carrier. Code (and/or data) to implement an embodiment of the disclosure described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The disclosure may comprise a controller which includes a microprocessor, working memory and program memory coupled to one or more of the components of the system.

It will also be clear to one of skill in the art that all or part of a logical method according to an embodiment of the present disclosure may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present disclosure may be realised in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present disclosure may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### BRIEF DESCRIPTION OF THE DRAWINGS

Implementations of the present disclosure will now be described, by way of example only, with reference to the accompanying drawings, in which:

FIG. 1 is a schematic diagram illustrating a system for federated learning, FL, referred to herein as “StreamingFL”;

FIG. 2 shows results of experiments to determine the reduced memory cost of training with small batch sizes;

FIG. 3 shows results of experiments to determine the challenges in training with reduced batches;

FIG. 4 is a schematic diagram showing a system for federated learning, the system comprising a server and at least one client device;

FIG. 5 is a schematic diagram of a system for federated learning using streaming and non-streaming updates;

FIG. 6 depicts an example in which the networking speed fluctuates over a period of time;

FIG. 7 depicts an example in which the memory budget changes over a period of time;

FIG. 8 shows the StreamingFL Algorithm;

FIG. 9 is a schematic diagram showing a client device;

FIG. 10 shows the results of experiments using ImageNet-1K to ImageNet-21K incremental learning datasets;

FIG. 11 is a schematic diagram showing how the present techniques may be used for visual recognition tasks on edge devices;

FIG. 12 is a flowchart of example steps to perform adaptable federated learning; and

FIG. 13 is a block diagram of a system for performing adaptable federated learning.

### DETAILED DESCRIPTION

Broadly speaking, embodiments of the present disclosure provide a method for performing federated learning, which is suitable for implementation by resource-constrained devices, such as smartphones and edge devices. However, the present disclosure is not limited in this regard, and the present disclosure may be implemented to any other devices.

As noted above, federated learning, FL, has become a popular area of research in recent years thanks to its privacy-preserving nature and capability to utilise the compute power of millions of user devices for the training of ML models.

In this context, the present disclosure provide “StreamingFL”, a novel FL approach that takes into account and alleviates the impact of the aforementioned practical aspects that have been overlooked by existing work on FL deployment.

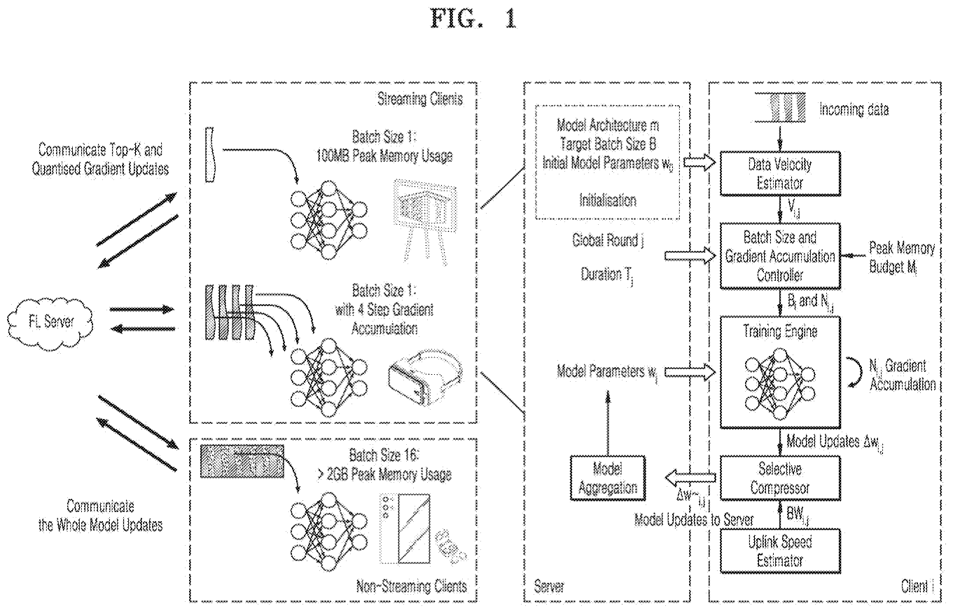

FIG. 1 is a schematic diagram illustrating a system for federated learning, FL, referred to herein as “StreamingFL”. The system takes into account practical aspects that have been overlooked by existing deployments of FL, e.g. progressively available data on client devices, spatial and temporal data heterogeneity, and memory-efficient training of upcoming models, such as Transformers, in incremental settings, e.g. training data distribution changes over time.

The present disclosure may comprise three components: i) streaming sub-epoch updates, which allow each client device to rapidly transmit updates when the uplink bandwidth is abundant, ii) memory-aware batching & data velocity-adaptive gradient accumulation (GA) that enable each client device to tune its batch size based on its memory budget and to match the number of the GA steps to the data generation speed that the client device experiences on the current round—these two methods combined enable the on-device training of memory-costly models without degrading the achieved accuracy, and iii) networking-aware switching between streaming and non-streaming modes, which allows each client device to dynamically balance its computation-to-communication ratio based on the quality of its uplink channel. The term “uplink bandwidth” is used herein to mean the bandwidth of the network used by the client device to communicate with the server (i.e. from client device to server). The term “data velocity” is used herein to mean is the rate of data item generation by the client device in terms of samples per second (samples/s). The client device may generate data items by taking readings from a sensor or capturing images from a camera, for example.

Experiments may show that StreamingFL is able to achieve 70% validation accuracy with ViT-base on ImageNet with 40% of the data required by baselines such as standard FL, while enabling the federated training of memory-heavy emerging models, such as Vision Transformers (ViT-base), on ubiquitous memory-constrained devices.

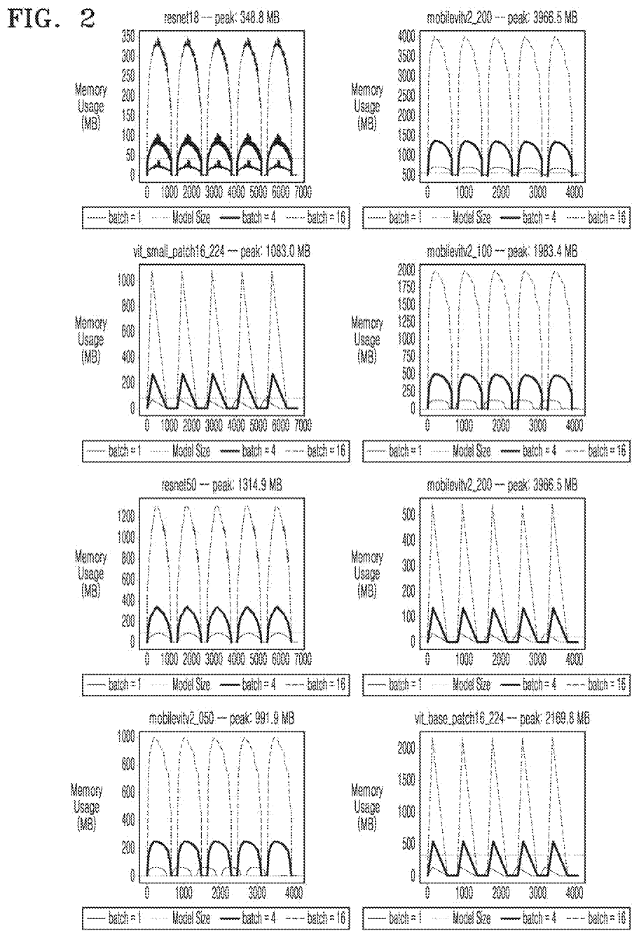

FIG. 2 shows results of experiments to determine the reduced memory cost of training with small batch sizes. The actual memory usage may be measured during training of various models, and model size (in dash-single dotted line) and activation memory is compared for different batch sizes. It may be seen that standard batch sizes (e.g. 16) lead to excessive memory footprint for activations, exceeding the model size memory by up to 26× for ViT models (ViT-tiny) and 228× for CNN-based models (MobileNetV2_050). Smaller batch sizes (e.g. 1 or 4) may reduce peak memory consumption, enabling memory-constrained devices to participate in the FL process.

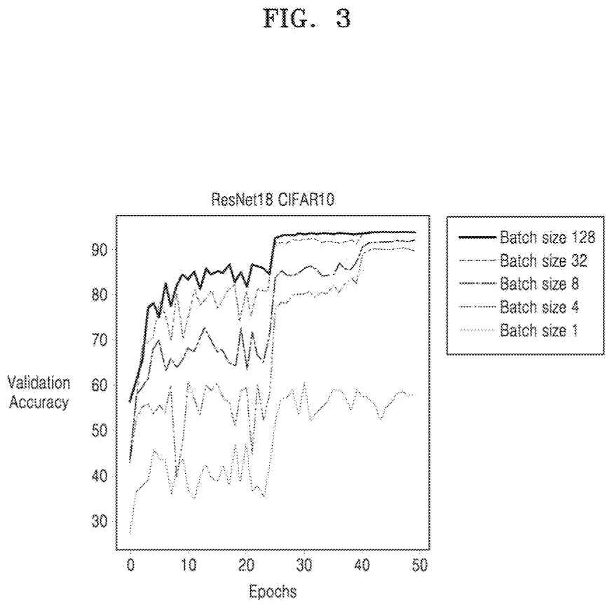

FIG. 3 shows results of experiments to determine the challenges in training with reduced batches. It may be seen that, despite the memory savings, small batches degrade either final accuracy or convergence (time-to-accuracy). To analyze the impact of using small batches, a centralized training of ResNet18 is run on the CIFAR10 dataset with various batch sizes {128, 32, 8, 4, 1}. The experiments show significant drop in terms of accuracy, i.e. ~30%, as the batch size decreases. In StreamingFL, this gap may be bridged through the Memory-Aware Batching and Data Velocity-Adaptive Gradient Accumulation methods, which may enable the utilisation of small batch sizes for memory savings without severely decreasing the attainable accuracy.

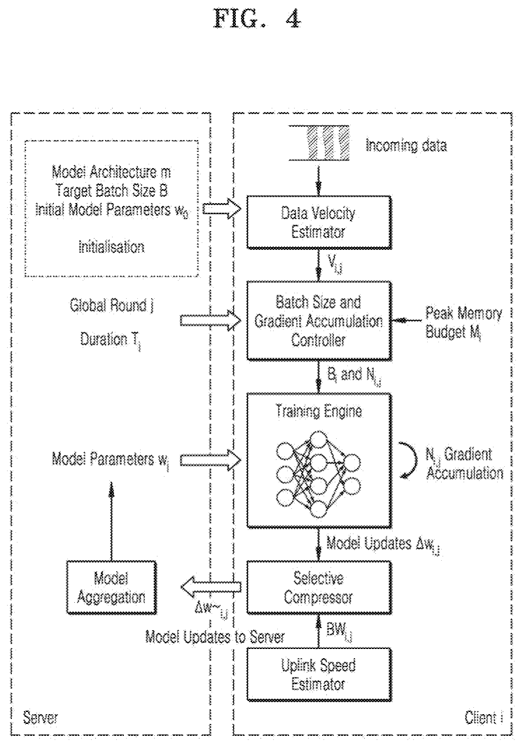

The StreamingFL System is now described with reference to FIG. 4. FIG. 4 is a schematic diagram showing a system for federated learning, the system comprising a server and at least one client device.

Sub-Epoch Updates: Related FL methods assume that each client processes their whole dataset at least once (e.g. going through at least one epoch) before sending an update to the server. Departing from this scheme, client devices using “StreamingFL” may forward their local updates to a server (which stores the global model) as soon as enough samples become available for training the local models stored on the client devices, instead of waiting for the completion of an entire epoch. This process may establish a continuous flow of updates that allows for the timely tracking of data distribution shifts and enables the global model to adapt to the new data efficiently in terms of the number of samples used.

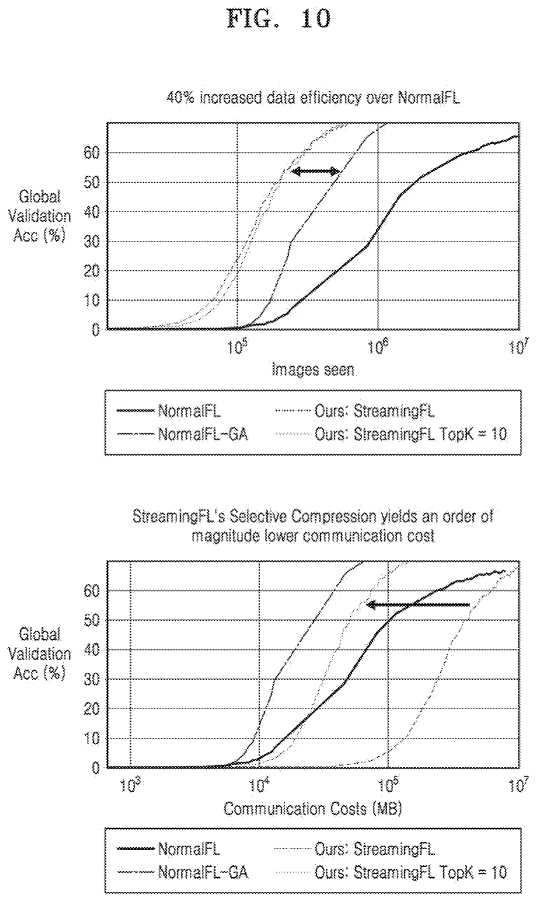

Memory-Aware Batching and Data Velocity-Adaptive Gradient Accumulation: At the beginning of an FL round j, a client device may receive the current global model from the server and perform an update on model weights using the incoming data samples arrived during time interval T, which is an agreed round duration across all participating clients. (Each client device receives all of the updated parameters of the global model. As explained in more detail below, when a communication network bandwidth is high, each client device may transmit all of the updated parameters of the local ML model, e.g. the differences between the parameters of the local ML model before and after local training. Alternatively, when a communication network bandwidth is low/poor, each client device may use uplink compression and only transmit the Top-K parameter updates with the largest difference before and after local training). A StreamingFL client device i may determine the local batch size Bᵢ based on the available memory budget Mᵢ and the model size. The number of gradient accumulation steps N_{i,j} may be adaptively derived based on the arrival rate v_{i,j} of the incoming samples, N_{i,j}=v_{i,j}T/Bᵢ. The intuition behind the adaptive gradient accumulation scheme is that when data arrive slowly (small v_{i,j}), the client may perform prompt updates with the available data during the time budget for current round t, instead of waiting to receive an entire epoch of data as in conventional FL settings, preventing straggler cases due to slowly arriving data. In an embodiment, when the data velocity v_{i,j} is high, the client will incorporate as many steps of gradients as possible to send to the server. As shown in the experimental results (see FIG. 10), StreamingFL may enable the use of upcoming, but memory-heavy, models, such as Transformers, on memory-constrained client devices, while simultaneously achieving data-efficient training compared to non-streaming FL baselines.

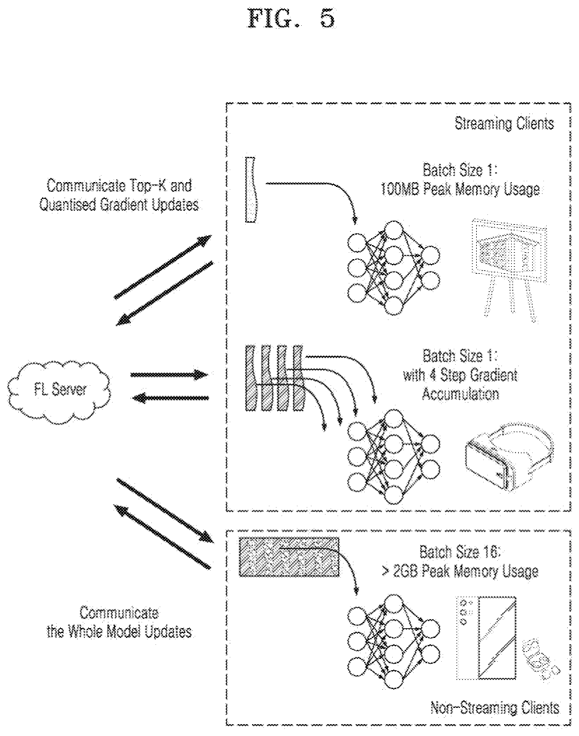

FIG. 5 is a schematic diagram of a system for federated learning using streaming and non-streaming updates.

Hybrid Streaming and Non-Streaming Updates & Selective Compression: Frequent communication of updates may enable data-efficient training, but at the same time it introduces communication overhead. To alleviate this, StreamingFL clients may switch between streaming (i.e. more frequent, sub-epoch updates) and non-streaming (i.e. less frequent, full-epoch updates) modes, based on 1) the quality of the client's networking conditions as well as 2) the model size. This operation may be explained in more detail below.

Similarly, the model may update transferred upstream are selectively compressed via the Selective Compressor module (see FIG. 4), which communicates only the Top-K percent of the updates based on the client's networking conditions. In an embodiment, the Top-K percent of the updates are those parameters which have the most impact on the global ML model, e.g. the parameters of the local ML model which have changed the most before and after local training during the sub-epoch or epoch updates.

Example cases for Hybrid Streaming and Non-Streaming Updates, considering networking speed and model size, are now described. Note that in the streaming mode, sub-epoch updates may be used. Parameter β may be set by the system operator and captures the minimum number of model updates per time interval (e.g. minimum updates per second for each client) in the streaming mode. The following four examples may be used to detail how StreamingFL's hybrid streaming and non-streaming modes work, given different values of β:
High networking speed BW and small NN model size m: If β<p, streaming mode with p updates per time interval, else non-streaming. This is the most common case where streaming is used. Selective Compression is typically not needed.

High networking speed BW and large NN model size y*m: If β<p/y, streaming mode with p/y updates per time interval, else non-streaming. Streaming mode is mostly used in this case, unless the NN model size is excessively large. Selective Compression can often alleviate the large NN model size and again enable streaming.

Slow networking speed BW/x and small NN model size m: If β<p/x, streaming mode with p/x updates per time interval, else non-streaming. Due to the small NN model size, streaming mode is mostly used. Selective Compression can sometimes be used if the networking speed is severely limited.

Slow networking speed BW/x and large NN model size y*m: if β<p/y/x, streaming mode with p/y/x updates per time interval, else non-streaming. Non-streaming mode is typically used.

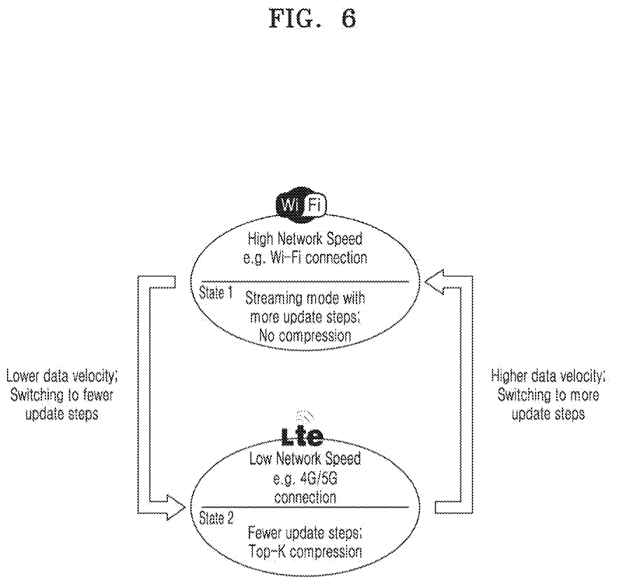

Referring to FIG. 6, in a real-world deployment, the user can experience dynamic network conditions and memory budget. StreamingFL is designed to be able to cope with such changes efficiently, and thereby improve user experience of their devices in at least two ways. Firstly, client devices perform FL with existing hardware usage in mind, so that, for example, if a user is using the client device to make a video call, or stream and watch a movie, their experience is not negatively impacted. Secondly, client devices that participate in FL have models which are better personalized for the user, because they have been further trained using data items collected in the user's environment, and therefore, perform better for the user.

FIG. 6 depicts an example in which the networking speed fluctuates over a period of time. StreamingFL adjusts to these changes as follows. Starting from State 1, where the user has good Wi-Fi connection for both uplink and downlink transfers, the StreamingFL client may detect that the effective data velocity v_{i,j} is high. Hence, it may perform more local optimization steps (small t_{i,j}), and the clients may not perform compression when sending their model updates to the server. When the user moves from one room to another in their home/office or when an excessive number of devices share the Wi-Fi bandwidth, the Wi-Fi signal strength may either drop substantially or its speed may get throttled. In an instance, the user's device may fall back to 4G/5G connectivity, which leads to significantly lower speed. In an embodiment, StreamingFL may fall back to a large t_{i,j}, e.g. less frequent model optimization, operating in State 2. As the uplink signal weakens and the throughput drops, the StreamingFL client will start to compress its model updates before transmitting them to the server. When the Wi-Fi connectivity is restored, the client may switch back to State 1, in which they perform frequent local optimization steps and no compression.

A similar scenario is when the server adjusts its speed of transmission. In this case, the effective data velocity may also change and it may lead to all clients adjusting their frequency of updates. In an embodiment, the server may switch to non-streaming mode for all clients. In an embodiment, as long as the clients-to-server uplink connection remains the same, the clients may not perform compression, so that the model updates may still be incorporated in the global model in the most rapid fashion possible.

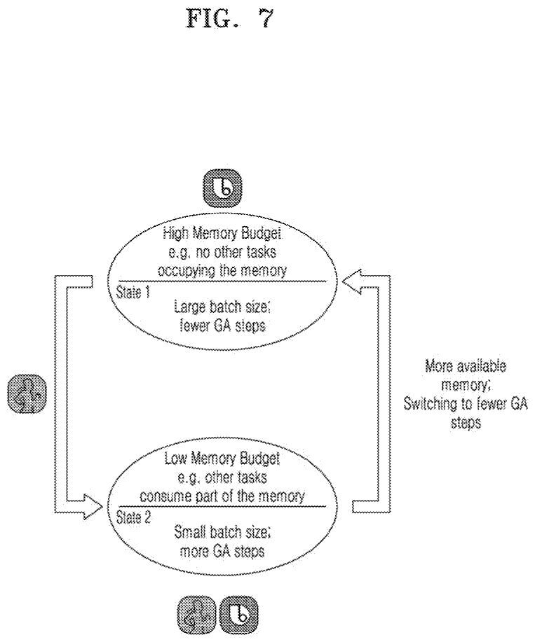

FIG. 7 depicts an example in which the memory budget changes over a period of time. In an embodiment, the user may participate in a workout session using an application on their phone, while a StreamingFL client is running a training session for its voice assistant's automatic speech recognition (ASR). While other system attributes remain constant, the StreamingFL client may adapt to the changes in the following manner. Starting from State 1, where the StreamingFL client has access to all the available memory of the target computing unit, it may be able to perform single-step updates with larger batch sizes. Given the target batch size B is fixed, the client may perform a small number of GA steps. The user starts their workout session using the Samsung Health APP to track their activity, which may use a visual recognition neural network model that performs its inference on the same computing unit as the StreamingFL client training of the Bixby ASR model. The available compute memory for the StreamingFL training session may decrease significantly. In an embodiment, StreamingFL will switch to smaller batch sizes and start to accumulate more gradient steps per update. Once the user finishes their workout session, the StreamingFL client may regain exclusive access to the available memory, and may switch back to State 1, where it performs large batch size training and fewer GA steps.

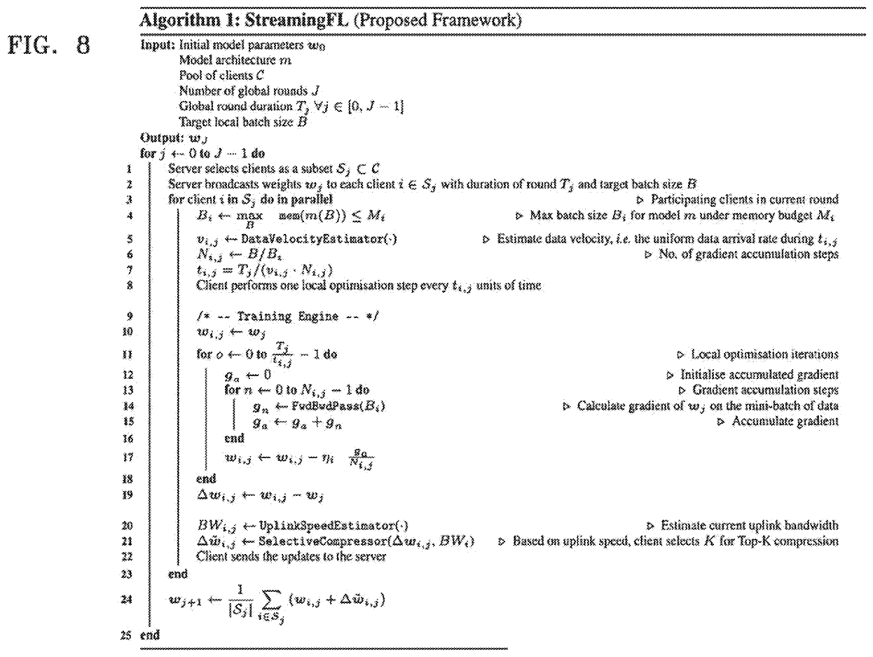

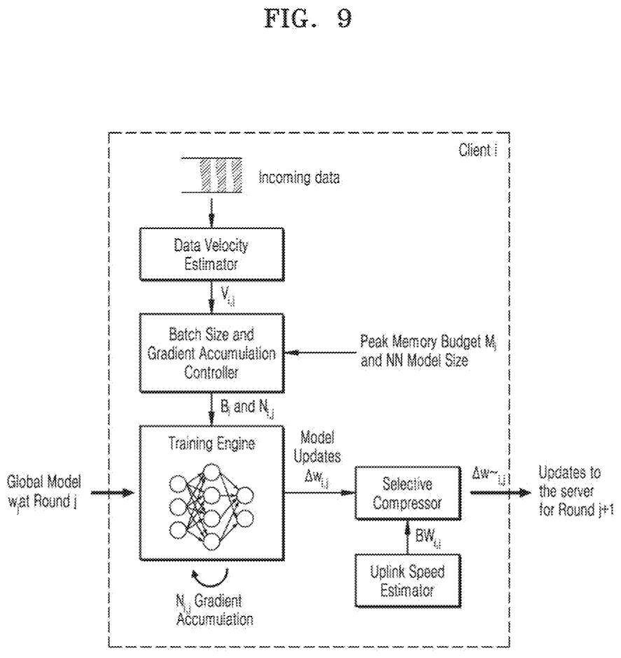

FIG. 8 shows the StreamingFL Algorithm. Referring to FIG. 8 and the client device in FIG. 9, the processing flow of StreamingFL clients is now described. In an embodiment, prior to deployment, the server may set the input parameters Tj and B which are the timeout of the j-th global round and the target local batch size, respectively. Parameter B may determine the minimum amount of data that need to be processed locally, before a client transmits an update back to the server.

Upon deployment, incoming data samples may be continuously received in the input queue of each participating client (top of FIG. 9). First, the Data Velocity Estimator may maintain a running estimate v_{i,j} of the arrival rate in samples/s (line 5 of the Algorithm in FIG. 8). Next, the Batch Size and Gradient Accumulation (GA) Controller may set the batch size Bᵢ based on the target global target batch size B, the model m and the memory budget of the i-th client device Mᵢ (line 4).

The Controller may set the number of GA steps N_{i,j} by considering B and Bᵢ. Parameters Bᵢ and N_{i,j} are used to configure the Training Engine.

In an embodiment, the Training Engine may perform Tⱼ/t_{i,j} local updates (lines 11-18), using N_{i,j} GA steps and a batch size of Bᵢ for each step. The final model updates (line 19) may be selectively compressed by the Selective Compressor based on the uplink networking speed BW_{i,j}, which is estimated by the Uplink Speed Estimator. The data velocity and uplink speed estimations may occur once per global round, under the assumption that they do not change radically in the round's duration.

The final version of the model updates [symbol] (line 21) may be sent back to the server for the model aggregation step (line 24).

### Results.

FIG. 9 shows the results of experiments using ImageNet-1K to ImageNet-21K incremental learning datasets. For the empirical evaluation, StreamingFL was implemented using PyTorch and integrated it into the Flower framework as described in Beutel, Daniel J., Taner Topal, Akhil Mathur, Xinchi Qiu, Javier Fernandez-Marques, Yan Gao, Lorenzo Sani et al. “Flower: A friendly federated learning research framework.” arXiv preprint arXiv: 2007.14390 (2020). Incorporated by reference. To emulate real-world settings, a method to produce novel datasets for federated incremental learning is emulated as follows.

Dataset Synthesis and Partitioning: All classes in ImageNet-21K (Deng, J., Dong, W., Socher, R., Li, L. J., Li, K., Fei-Fei, L.: ImageNet: A Large-Scale Hierarchical Image Database. In: CVPR (2009) may be ranked based on their semantic distances (in WordNet) to all ImageNet-1K labels. The 1000 most dissimilar classes may be selected, and the dataset may be partitioned among 1000 client devices. This step may be performed following Latent Dirichlet Allocation (LDA) partitioning with parameter alpha controlling the non-IID-ness, where lower values of alpha imply higher data heterogeneity. In an embodiment, the dataset may be designed to simulate the fact that client devices'data are different from each other in reality. In an embodiment, for different simulations, it may be desirable to have different levels of dissimilarity among the client devices'data. The way this is done is to partition the ImageNet-21K based on LDA, so that images of different classes (e.g. cats, dogs) may be partitioned with a tunable level of heterogeneity (one client might have more cats and the other more dogs), where this level is determined by a parameter alpha (in one setting client A and client B both have cats and dogs, then it means high alpha/low heterogeneity; versus a setting where client A has only cats and B only dogs, then it means low alpha/high heterogeneity. The latter may ensure the simulations are much more reflective of the real-world differences in data of client devices).

Baselines: The performances of StreamingFL are compared to three baselines: i) Normal FL, which represents the widely used FedAvg method, ii) Normal FL with Gradient Accumulation (GA), and iii) StreamingFL with TopK, an enhanced variant of StreamingFL where each client transmits only Top-K percent of its model updates to reduce the uplink communication cost.

FL Settings: During the evaluation, for each FL round, ten client devices are randomly sampled/chosen to participate in the training. The server transmits the updated global model to the participating client devices, and the client devices optimise their local model using an SGD optimiser with a learning rate of 0.01 using their local partition of data. Once the updates of model weights are transmitted to the server, the server will average these and update the global model for the following round. The simulated FL training lasts 2000 rounds in total.

FIG. 10 shows the achieved accuracy under the same setup for all methods, i.e. batch size of 1, the ViT-Base architecture, LDA alpha=0.1 for data partitioning across clients, and where applicable, each client accumulates the gradients over 32 GA steps. In an embodiment, FIG. 10 shows validation accuracy of StreamingFL, StreamingFL with Top-K, Normal FL, and Normal FL with Gradient Accumulation (GA) on ImageNet21K-selected-1K dataset, with the most heterogeneous data partitioning (LDA alpha=0.1) across clients.

The upside graph in FIG. 10 shows the achieved accuracy as a function of the images seen. It is observed that StreamingFL may enable the same validation accuracy to be reached as Normal FL on ImageNet, while requiring around 40% of the data, when targeting ViT-Base. In an embodiment, StreamingFL may be able to provide more data-efficient federated learning and lead to faster adaptation to any data distribution changes, without the need for the clients to excessively wait for more data to become available.

The downside graph in FIG. 10 shows the achieved accuracy as a function of the communication cost. While StreamingFL's regular flow of model updates from the clients induces additional communication cost, this graph may demonstrate that by introducing the Top-K compression for the uplink client-to-server transmission of the model updates (i.e. StreamingFL TopK=10 in the figure), the communication overhead may be significantly alleviated. In an embodiment, it may lead to a reduction of 10× in the amount of transferred data, while maintaining the same level of accuracy, making StreamingFL a deployable approach.

Example uses of the present disclosure are now described.

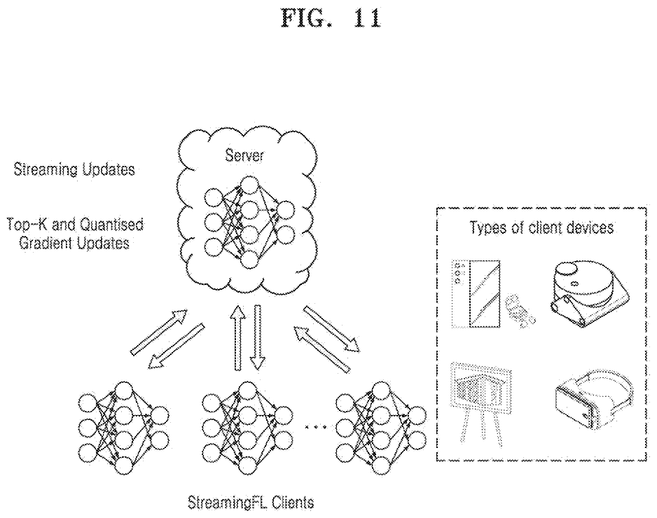

FIG. 11 is a schematic diagram showing how the present disclosure may be used for visual recognition tasks on edge devices. Edge devices, such as mobile phones, robot vacuum cleaners and AR glasses, often perform visual recognition tasks for specific applications on private user data. StreamingFL may allow for learning useful updates from incoming data on users'edge devices without sharing private information to a cloud/remote server.

The memory capacity of such edge devices is usually limited. With recent state-of-the-art vision models, such as ViT-based architectures, consuming significantly more memory footprint (2×-10×) than CNNs, an excessive number of devices are excluded from the FL process due to out-of-memory issues. This in turn degrades the global model accuracy, as the data residing in memory-constrained devices are not seen during training.

StreamingFL may enable training with small memory footprint by tailoring each client device's batch size to its memory capacity constraint. In an embodiment, by monitoring the speed of data generation on the user device, the StreamingFL client may adapt to suitable gradient accumulation rate, leading to both effective learning and fast integration of new updates to the global model.

An example use of the present disclosure for visual recognition tasks on edge devices is described. Mobile devices are often connected wirelessly to local area networks, the bandwidth of which vary across devices and over time. StreamingFL may allow the clients to switch between streaming and non-streaming mode based on network connectivity. In an embodiment, it may either i) exploit the fast networking for data-efficient training through streaming updates or ii) it save communication cost by performing more computation per upstream communication through the non-streaming mode.

Image data observed by edge devices often need to adapt to global trends and events such as a new social media (e.g. TikTok/Instagram) trend or sudden events, such as a global pandemic. In an embodiment, StreamingFL may be able to promptly capture new global trends in the server updates and thereby achieve both timeliness (relevance) and data efficiency.

The present disclosure may be used to perform federated learning using consumer robotic devices. Mobile agents, such as vacuum cleaner or pet monitoring robots, typically operate in long cycles during which DNNs are used to identify and avoid obstacles, as well as interact with the user. As such, rapid (online) consumption of newly-generated training data (e.g. arising after a collision) and adaptation of the deployed DNN models is required after a failure, to avoid the repetition of predictive errors that have a direct impact on user-experience.

In an embodiment, with training datasets for robot applications being orders of magnitude smaller than other domains, sharing experience between robots in a privacy-preserving manner is a key technology to enable the creation of large-scale generalisable robot perception models.

Typically constrained by limited storage capacity, this adaptation needs to happen on-the-fly. Furthermore, as it is common for a large set of failures to occur during the initial “calibration” phase, where the robot's model is personalized to the user's environment, traditional approaches (model fine-tuning with large number of local iterations before aggregation) may lead to client drift degrading the accuracy of the global model.

The present disclosure may remedy this issue, allowing for rapid adaptation of the local model while facilitating better alignment through continuous integration with the global model. In an embodiment, this may enable a faster sharing of gained experience between devices, collectively leading to an improvement in user experience.

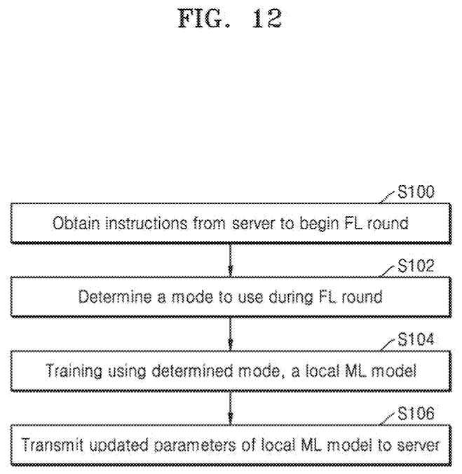

FIG. 12 is a flowchart of example steps to perform adaptable federated learning of a global machine learning, ML, model, at a client device. The method may comprises receiving, from a server, instructions to begin a FL round (step S100). The method may comprise determining a mode to use during the FL round, wherein the mode is one of a streaming mode and a non-streaming mode (step S102). The method may comprise training, using the determined mode, a local ML model stored at the client device, the local ML model corresponding to the global ML model (step S104). The method may comprise transmitting a plurality of updated parameters of the local ML model to the server when the training is complete (step S106).

At step S100, the method may comprise receiving, from the server, current parameters for a local ML model at the start of the FL round, wherein the current parameters are obtained from a global ML model. The method may comprise modifying the local ML model using the received current parameters. In an embodiment, at the start of an FL round, the client device may receive the current parameters of a local ML model to be trained. The current parameters may be generated, at the server, by conducting an aggregation of the local ML models from client devices that participated in a previous FL round. In this way, the client device may train the most up-to-date version of the local ML model (i.e. the local version of the global ML model) during each FL round.

Receiving instructions to begin a FL round (step S100) may comprise receiving a predefined FL round duration and a predefined minimum number β of model updates to be performed in the FL round duration. In an embodiment, the server may specify how many epochs (also referred to as updates) are to be performed in each FL round. The server may specify a number of data items that need to be included in each epoch.

Determining a mode to use during the FL round (step S102) may comprise using a current communication network speed of the client device and a size of the local ML model (where “size of the local model” means the total number of parameters of the model) to determine whether to use the streaming mode or non-streaming mode. In an embodiment, as mentioned above, a quality of the communication network/connection is used to determine whether to use a streaming mode or non-streaming mode. A streaming mode may be used when the communication network speed is currently low, and/or the model size is large. This means that a client device would perform more training of the local ML model, but using fewer data items than required for a full epoch, and transmit the updated parameters to the server more often. The computational inefficiency (e.g. reduced amount of computation per communication round compared to a full-epoch approach) may be balanced by the reduction in pressure on the hardware resources of the client device, and a risk of failed transmissions is also reduced.

Determining a mode to use during the FL round (step S102) may comprise determining a number p of updates that the client device is able to perform during the FL round. Determining a mode to use during the FL round (step S102) may comprise comparing the received predefined minimum number β of model updates to be performed with the determined number of updates p. In an embodiment, the client device may compare what is required by the server with what the client device is able to perform, given a number of factors. In an embodiment, determining a number p of updates that the client device is able to perform during the FL round may comprise using an arrival rate of data items at the client device. In an embodiment, determining a number p of updates that the client device is able to perform during the FL round may comprise using the predefined FL round duration. In an embodiment, determining a number p of updates that the client device is able to perform during the FL round may comprise using a batch size of a batch of training data items for training the local ML model.

The method shown in FIG. 12 may comprise determining the batch size using an available memory for the training of the local ML model and the size of the local ML model. In an embodiment, the hardware capabilities of the client device may be taken into consideration when determining the batch size. If a client device has lots of memory available because, for example, it is not resource-constrained or because memory is not being utilised presently, then the batch size may be larger. The client device may choose when to perform the FL round, to ensure there is sufficient memory available. For example, if the client device is a smartphone, the client device may perform the FL round when the smartphone is being charged or when the device is in a ‘do not disturb’state (as may be the case when a user of the device is asleep).

In cases where the non-streaming mode is used, the step (S106) of transmitting a plurality of updated parameters of the local ML model to the server may comprise selecting a subset of the plurality of updated parameters and compressing the selected subset prior to the transmitting. In an embodiment, the client device may only send some of the updated parameters to the server to avoid increasing the size of the data to be transmitted while the communication network speed is low.

The method may further comprise capturing data items for use when training the local ML model. In an embodiment, the client device may actively capture data items for use during the present FL round. The data items may be of any type, and depend on the tasks of the local and global ML models. In one example, the global ML model and local ML model are for object recognition tasks, and capturing data items may comprise capturing images or frames of videos. The data items may include some data items that are similar to data items seen by the global ML model during pre-training of the global ML model (prior to the federated learning), and some data items that are different to those seen by the global ML model during pre-training. The visual perception tasks may be object detection, object recognition, object tracking, image denoising, image segmentation, image classification, image super-resolution, and so on. It may be understood that this is a non-limiting and non-exhaustive list of example tasks.

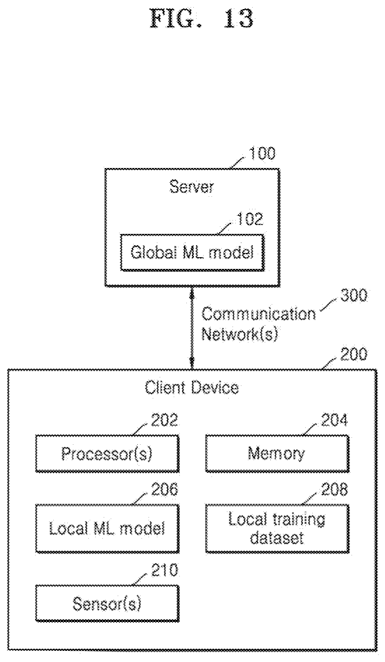

FIG. 13 is a block diagram of a system for performing adaptable federated learning. The system may comprise a server 100, which stores a global ML model for a specific task, such as object detection. The server 100 may be able to communicate with a plurality of client devices.

The system may comprise a plurality of client devices 200. Although only one client device 200 is shown in FIG. 13 for the sake of simplicity, it may be understood that there may be tens, hundreds, thousands or hundreds of thousands of client devices 200 coupled to the same server 100.

The client devices 200 may be connected to the server 100 via a communication network(s) 300. For example, the client devices 200 may be able to communicate with the server 100 via a cellular/mobile network or via WiFi, or both. It will be understood that the client devices 200 may switch which communication network 300 they use to communicate with the server 100. For example, if the client device 200 is a mobile electronic device (such as a smartphone), the client device 200 may connect to WiFi in some environments (e.g. a user's home or workplace) and may connect to a mobile network in other environments. In some cases, the WiFi signal strength may be poor and the client device 200 may actively choose to switch to using a mobile network to communicate with the server 100. In an embodiment, changes in which communication network the client devices 200 may be connected to may impact the mode used during a FL round.

Each client device 200 may comprise at least one processor coupled to memory for receiving, from a server, instructions to begin a FL round. Each client device 200 may comprise at least one processor coupled to memory for determining a mode to use during the FL round, wherein the mode is a streaming mode or a non-streaming mode. Each client device 200 may comprise at least one processor coupled to memory for performing, using the determined mode, training of a local ML model stored at the client device, which corresponds to the global ML model; and transmitting a plurality of updated parameters of the local ML model to the server when the training is complete.

Each client device 200 may comprise at least one processor 202 coupled to memory 204. The at least one processor 202 may one or more of: a microprocessor, a microcontroller, and an integrated circuit. The memory 204 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

Each client device 200 stores a local ML model 206, which corresponds to the global ML model 102 stored on the server 100. The local ML model 206 may be a copy of the global ML model 102, or may be a lightweight version of the global ML model 102 that is more suitable for use by resource-constrained devices.

Each client device 200 has a local training dataset 208. The local training dataset 208 may comprises data items used to perform the local training of the local ML model 206. Each client device 200 may comprise at least one sensor 210. The at least one sensor may be any sensor which is able to capture or collect data items that can be processed by the local ML model 206.

During an FL round (and otherwise), each client device 200 may actively capture data items for use during the present FL round, using the at least one sensor 210. The data items may be of any type, and depend on the tasks of the local and global ML models. In one example, the global ML model and local ML model are for visual perception tasks, and capturing data items may comprise capturing, using a camera 210, images or frames of videos.

Those skilled in the art will appreciate that while the foregoing has described what is considered to be the best mode and where appropriate other modes of performing present disclosure, the present disclosure should not be limited to the specific configurations and methods disclosed in this description of the preferred embodiment. Those skilled in the art will recognise that present disclosure has a broad range of applications, and that the embodiments may take a wide range of modifications without departing from any inventive concept as defined in the appended claims.

What is claimed is:

1. A computer-implemented method for adaptable federated learning (FL) of a global machine learning (ML) model, at a client device, the method comprising:
obtaining instructions to begin a FL round;
determining a mode to use during the FL round, wherein the mode is one of a streaming mode involving sub-epoch training and a non-streaming mode involving epoch training;
training, using the determined mode, a local ML model stored at the client device, the local ML model corresponding to the global ML model; and
transmitting a plurality of updated parameters of the local ML model when the training is complete.

2. The method as claimed in claim 1, further comprising:
obtaining current parameters for a local ML model at the start of the FL round, wherein the current parameters are obtained from the global ML model; and
modifying the local ML model using the obtained current parameters.

3. The method as claimed in claim 2, wherein the determining the mode to use during the FL round is based on a current communication network speed of the client device and a size of the local ML model.

4. The method as claimed in claim 3, wherein the obtaining the instructions to begin a FL round comprises obtaining a predefined FL round duration and a predefined minimum number of model updates to be performed in the FL round duration.

5. The method as claimed in claim 4, wherein the determining the mode to use during the FL round comprises:
determining a number of updates that the client device is able to perform during the FL round;
comparing the obtained predefined minimum number of model updates to be performed with the determined number of updates; and
determining the streaming mode is to be used in response to the obtained predefined minimum number of model updates to be performed is less than the determined number of updates the client device is able to perform.

6. The method as claimed in claim 5, wherein the determining the number of updates that the client device is able to perform during the FL round is based on:
an arrival rate of data items at the client device, wherein the data items are for training the local ML model;
the predefined FL round duration; and
a batch size of a batch of data items for training the local ML model.

7. The method as claimed in claim 6, further comprising determining the batch size based on an available memory of the client device for the training of the local ML model and the size of the local ML model.

8. The method as claimed in claim 7, wherein the determining the mode to use during the FL round comprises determining the streaming mode is to be used when:
the size of the local ML model is equal to a predefined size;
the current communication network speed is determined to be equal to a threshold speed; and
the obtained predefined minimum number of model updates to be performed is less than the determined number of updates.

9. The method as claimed in claim 8, wherein the determining the mode to use during the FL round comprises determining the streaming mode is to be used when:
the size of the local ML model is greater than the predefined size multiplied by a second scaling factor;
the current communication network speed is determined to be equal to a threshold speed; and
the obtained predefined minimum number of model updates to be performed is less than the determined number of updates divided by the second scaling factor.

10. The method as claimed in claim 8, wherein the determining a mode to use during the FL round comprises determining the streaming mode is to be used when:
the size of the local ML model is equal to the predefined size;
the current communication network speed is determined to be less than a threshold speed multiplied by a first scaling factor; and
the obtained predefined minimum number of model updates to be performed is less than the determined number of updates divided by the first scaling factor.

11. The method as claimed in claim 10, wherein the determining a mode to use during the FL round comprises determining the streaming mode is to be used when:
the size of the local ML model is greater than a predefined size m multiplied by a second scaling factor;
the current communication network speed is determined to be less than a threshold speed multiplied by the first scaling factor; and
the obtained predefined minimum number of model updates to be performed is less than the determined number of updates divided by the second scaling factor divided by the first scaling factor.

12. The method as claimed in claim 1, wherein when the non-streaming mode is used, transmitting the plurality of updated parameters of the local ML model comprises selecting a subset of the plurality of updated parameters and compressing the selected subset prior to the transmitting.

13. The method as claimed in claim 1, further comprising:
obtaining data items for use when training the local ML model during the FL round.

14. A client device for adaptable federated learning (FL) of a global machine learning (ML) model, the client device comprising:
at least one processor coupled to memory for:
obtaining, from a server, instructions to begin a FL round;
determining a mode to use during the FL round, wherein the mode is one of a streaming mode involving sub-epoch training and a non-streaming mode involving epoch training;
training, using the determined mode, a local ML model stored at the client device, the local ML model corresponding to the global ML model; and
transmitting a plurality of updated parameters of the local ML model to the server when the training is complete.

15. A non-transitory computer-readable medium configured to store instructions which, when executed by at least one processor, cause the at least one processor to perform the method of claim 1.
